(19) United States
(12) Patent Application Publication
(10) Pub. No.: US 2006/0221276 A1
(43) Pub. Date: Oct. 5, 2006

(54) Transflective liquid crystal display panel and color liquid crystal display device

(75) Inventors: Yoshifumi Masumoto, Fukushima-ken (JP); Sadao Nakamura, Fukushima-ken (JP); Takehiko Sone, Fukushima-ken (JP); Yasuhiro Miki, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/388,671

(22) Filed: Mar. 23, 2006

(30) Foreign Application Priority Data
Mar. 31, 2005 (JP) 2005-100277

(51) Int. Cl. G02F 1/1335

(52) U.S. Cl. 349/114

(57) ABSTRACT

A transflective liquid crystal display panel includes: a transflective layer having a reflective film provided so as to reflect light incident from the second substrate side, a transmissive opening portion being formed on a part of the reflective film so as to transmit light incident from the first substrate side therethrough; and a color filter layer having color filters corresponding to different colors buried in dot-corresponding regions of the transflective layer partitioned by the black matrix layer. The color filter layer has a reflective opening portion for exposing the part of the reflective film.

### BACKGROUND OF THE INVENTION

1. Field of the Invention

The present invention relates to a transflective liquid crystal display panel having a transmission function and a reflection function and a color liquid crystal display device which performs a color display by using the transflective liquid crystal display panel.

2. Description of the Related Art

In recent years, in a portable electronic device, such as a mobile phone or a portable game device, since battery driving time largely affects use conditions, a transflective liquid crystal display device capable of reducing the power consumption is used as a display unit. The transflective liquid crystal display device performs, for example, under a bright place, display in a reflective mode by turning off a backlight disposed at the bottom side of a liquid crystal display panel, and under a dark place, performs display in a transmissive mode by turning on the backlight disposed at the bottom side of the liquid crystal display panel. In the transflective liquid crystal display device, there is used, for example, a transflective liquid crystal display panel in which a reflective film, by which light incident from the front side of the transflective liquid crystal display device is reflected, is formed within the liquid crystal display panel and an opening portion through which light, which is emitted from the backlight and is incident from the bottom side of the transflective liquid crystal display device, is transmitted is formed. In addition, for color display of the transflective liquid crystal display panel, three dots (sub-pixels), which are respectively provided with color filters corresponding to red, green, and blue colors, forms one unit pixel.

In the transflective color liquid crystal display device, light is transmitted through the panel twice in the reflective mode but the light is transmitted through the panel once in the transmissive mode. For this reason, in the case in which the film thicknesses of the color filters corresponding to red, green, and blue colors are set to be equal and the coloring levels thereof are set to be equal, a problem occurs in that, in order to obtain clear color display in the reflective mode, a color in the transmissive mode becomes faint and thus color reproducibility in the transmissive mode becomes worse. In contrast, in order to perform the clear color display in the transmissive mode, a problem occurs in that a color in the reflective mode becomes dark and thus sufficient brightness cannot be obtained.

For this reason, for example, JP-A-11-183891 proposes a technique of dividing a pixel region into a peripheral region corresponding to a color filter and a central region not corresponding to the color filter and performing high-brightness color display by using colored light, which is light emitted from the peripheral region, and non-colored light, which is light emitted from the central region. However, in the technique disclosed in JP-A-11-183891, since the reflective film is disposed at the bottom side of a substrate with a polarizer interposed therebetween, it is difficult to obtain a bright reflection characteristic. In addition, since the opening portion of the color filter is formed at approximately the central portion of the pixel region, the opening portions are provided between scanning lines so as to be periodically repeated. As a result, in some patterns displayed, a so-called grid effect may occur in which the arrangement of opening portions on adjacent scanning lines is viewed in a stripe shape so as to be deviated by one line.

Further, JP-A-2002-122859 proposes a technique of setting the transmittance of a color filter, which is formed at the location corresponding to a transmissive region within a pixel region, to be lower than that of a color filter, which is formed at the location corresponding to a reflective region within the pixel region so as to improve the color saturation in the transmissive region. However, in the technique disclosed in JP-A-2002-122859, even though the desired color reproducibility can be obtained in both the reflective and transmissive modes by setting the optical concentration (including absorbency or film thickness) of the color filter to be low in the reflective region, there is a possibility that a desired result will not be obtained with respect to reflection-viewing angle characteristic of the reflective film used in combination with the color filter. That is, even though the reflective film is disposed within the panel, since the surface shape of the reflective film is determined by a melted state of a resist layer, it is almost impossible to control the cross-sectional shape of the reflective film. Accordingly, the reflection-viewing angle characteristic in this case shows only the Gaussian distribution in which a predetermined specular direction is set as an axis of symmetry. As a result, in order to obtain a desired reflection-viewing angle characteristic, a very strict management with respect to process conditions is required. This is because the desired reflection-viewing angle characteristic can be obtained by controlling the distribution of a cross-sectional angle of inclination with respect to the surface of the reflective film according to the design.

### SUMMARY OF THE INVENTION

The invention has been finalized in view of the drawbacks inherent in the related art, and it is an object of the invention to provide a transflective liquid crystal display panel and a color liquid crystal display device, which is capable of obtaining high-brightness color display with excellent color reproducibility in both transmissive and reflective modes, being manufactured in a simple manufacturing process, and preventing a manufacturing cost from rising.

According to an aspect of the invention, a transflective liquid crystal display panel includes: first and second substrates disposed to be opposite to each other; a liquid crystal layer sealed between the first and second substrates; a transflective layer having a reflective film formed on a surface of the first substrate facing the liquid crystal layer so as to reflect light incident from the second substrate side, a transmissive opening portion being formed on a part of the reflective film so as to transmit light incident from the first substrate side therethrough; a black matrix layer which is formed on the transflective layer so as to partition dot-corresponding regions corresponding to respective dots and extends in at least one direction of a surface including the dot-corresponding regions; and a color filter layer which has color filters corresponding to different colors disposed in the dot-corresponding regions of the transflective layer partitioned by the black matrix layer, the color filters being periodically arranged. The color filter layer has a reflective opening portion for exposing the part of the reflective film.

In the transflective liquid crystal display panel, preferably, one unit pixel is formed by three dots corresponding to primary colors of red, green, and blue.

Further, in the transflective liquid crystal display panel, preferably, the reflective film has a plurality of fine concave or convex portions formed on a surface thereof.

Furthermore, in the transflective liquid crystal display panel, preferably, the black matrix layer is formed in a direction along sides of the respective dots.

Furthermore, in the transflective liquid crystal display panel, preferably, the reflective opening portion is formed at a location within each of the dot-corresponding regions, the location being defined by the black matrix layer.

Furthermore, in the transflective liquid crystal display panel, preferably, the pair of reflective opening portions is formed at locations defined by the black matrix layers which are disposed to be opposite to each other with each of the dot-corresponding regions interposed therebetween.

Furthermore, in the transflective liquid crystal display panel, preferably, the pair of reflective opening portions is formed at approximately the same locations with respect to a longitudinal direction of each of the dot-corresponding regions.

Furthermore, in the transflective liquid crystal display panel, preferably, the transmissive opening portion is provided to be disposed further inward of the dot-corresponding region than the reflective opening portions.

Furthermore, in the transflective liquid crystal display panel, preferably, the transmissive opening portion is provided to be disposed between the pair of reflective opening portions within each of the dot-corresponding regions.

Furthermore, in the transflective liquid crystal display panel, preferably, the plurality of reflective opening portions is provided within each of the dot-corresponding regions.

Furthermore, in the transflective liquid crystal display panel, preferably, the plurality of transmissive opening portions is provided within each of the dot-corresponding regions.

Furthermore, in the transflective liquid crystal display panel, it is preferable that, in the color filter layer, the aperture ratio of the reflective opening portion in each of the dot-corresponding regions be set to be different for each of the color filters corresponding to the different colors. Specifically, in a case in which the color filter layer has a structure in which color filters corresponding to red, green, and blue colors are periodically arranged, it is preferable to set the aperture ratio of the reflective opening portion such that the aperture ratio of the reflective opening portion in the dot-corresponding region formed with the green color filter is highest and the aperture ratio of the reflective opening portion in the dot-corresponding region formed with the red color filter is lowest.

Furthermore, in the transflective liquid crystal display panel, it is preferable that, in the transflective layer, the aperture ratio of the transmissive opening portion in each of the dot-corresponding regions be set to be different for each of the color filters corresponding to the different colors. Specifically, in a case in which the color filter layer has a structure in which color filters corresponding to red, green, and blue colors are periodically arranged, it is preferable to set the aperture ratio of the transmissive opening portion such that the aperture ratio of the transmissive opening portion in the dot-corresponding region formed with the red color filter is highest and the aperture ratio of the transmissive opening portion in the dot-corresponding region formed with the green color filter is lowest.

Furthermore, in the transflective liquid crystal display panel, it is preferable that, in the transflective layer, fine concave portions, each of which a surface forms a part of a spherical surface, be irregularly formed on a surface of an organic film formed below the reflective film so as to be adjacent to one another, and thus a plurality of fine concave portions be formed on a surface of the reflective film formed on the organic film.

According to another aspect of the invention, a color liquid crystal display device includes: the transflective liquid crystal display panel described above; and a backlight that illuminates light from the first substrate side of the transflective liquid crystal display panel.

As described above, according to the invention, since the transmissive opening portion is formed on the part of the reflective film and the reflective opening portion through which the part of the reflective film is exposed is formed on the color filter layer, it is possible to perform high-brightness color display with excellent color reproducibility in a transmissive mode and to perform high-brightness color display with excellent color reproducibility in a reflective mode even when the film thicknesses of color filters are set to be equal and the coloring levels thereof are set to be equal. In addition, according to the invention, since the sectional shape of the reflective film can be controlled according to the design, it is possible to obtain a desired reflection-viewing angle characteristic and to obtain an even more high-brightness color display with the excellent color reproducibility in a reflective mode.

In addition, in the invention, since the reflective opening portions of the color filter layer are provided at the locations, which are defined by the black matrix layer, within the dot-corresponding region, it is possible to even more planarize a surface of the overcoat layer which covers the transflective layer on which the black matrix layer and the color filter layer are formed. As a result, it is possible to reduce the thickness difference between a portion of the liquid crystal layer corresponding to the transmissive opening portion and a portion of the liquid crystal layer corresponding to the reflective opening portion and to reduce the difference between driving voltages in transmissive and reflective modes.

### BRIEF DESCRIPTION OF THE DRAWINGS

FIG. 1 is a cross-sectional view illustrating the configuration of a color liquid crystal display device according to the invention;

FIG. 2 is an enlarged plan view illustrating a group of pixels of a transflective liquid crystal display panel included in a color liquid crystal display device shown in FIG. 1;

FIG. 3 is an enlarged plan view illustrating a transmissive opening portion formed on a reflective film and a reflective opening portion formed on a color filter in a dot-corresponding region corresponding to three dots forming each pixel;

FIG. 4 is an enlarged perspective view illustrating one dot-corresponding region of a transflective layer;

FIG. 5 is a perspective view schematically illustrating a concave portion formed on a reflective film shown in FIG. 4;

FIG. 6 is a cross-sectional view illustrating the shape of a surface of the concave portion shown in FIG. 5 at a specific longitudinal section plane X;

FIG. 7 is a perspective view schematically illustrating a convex portion formed on the reflective film;

FIG. 8 is a view schematically illustrating a method of measuring a reflection-viewing angle characteristic;

FIG. 9 is a graph illustrating the reflection-viewing angle characteristic when an azimuth angle of the reflective film shown in FIG. 4 is ø=0°;

FIG. 10 is a graph illustrating the reflection-viewing angle characteristic when an azimuth angle of the reflective film shown in FIG. 4 is ø=90°;

FIG. 11 is a graph illustrating the reflection-viewing angle characteristic when an azimuth angle of the reflective film shown in FIG. 4 is ø=270°;

FIG. 12 is an enlarged cross-sectional view illustrating the transmissive opening portion formed on the reflective film and the reflective opening portion formed on the color filter in the dot-corresponding region of the liquid crystal display panel shown in FIG. 1; and

FIG. 13 is an enlarged cross-sectional view illustrating a transmissive opening portion formed on a reflective film and a reflective opening portion formed on a color filter in a dot-corresponding region of a liquid crystal display panel shown as a comparative example.

### DESCRIPTION OF THE PREFERRED EMBODIMENT

Hereinafter, a transflective liquid crystal display panel and a color liquid crystal display device to which the invention is applied will be described with reference to the accompanying drawings. In the respective drawings used in the description below, to make each layer or each member to be sufficiently understandable size, each layer or each member is shown in a different reduced scale.

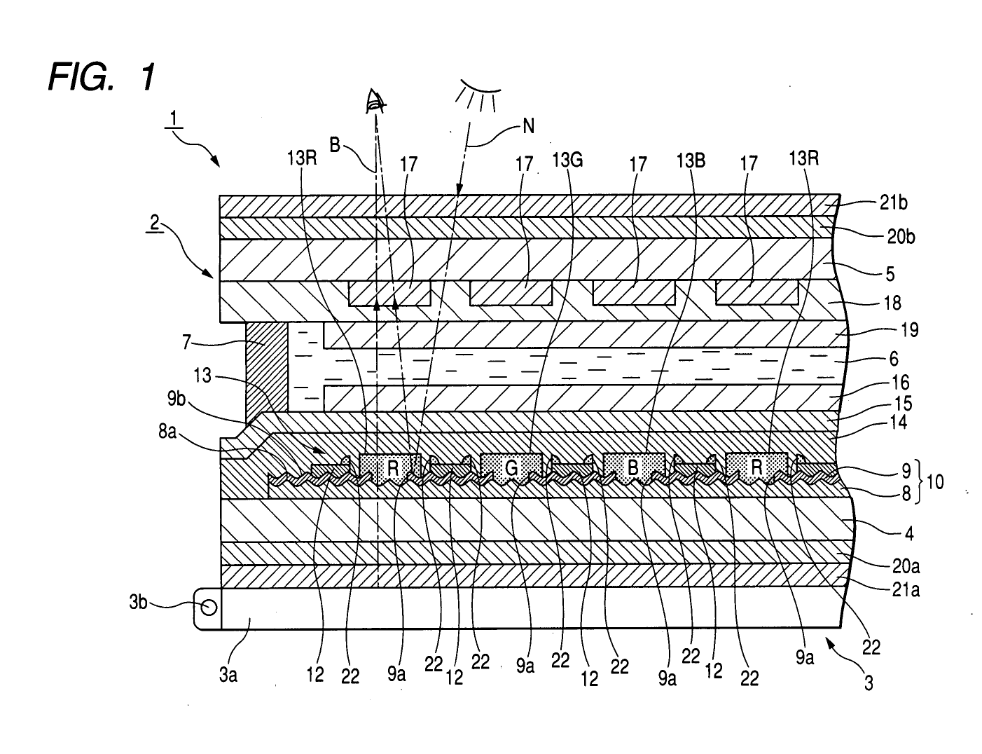

As shown in FIG. 1, the color liquid crystal display device 1 according to the invention includes a transflective liquid crystal display panel (hereinafter, referred to as ‘liquid crystal display panel’) 2 and a backlight 3 disposed at the bottom side of the liquid crystal display panel 2. The backlight 3 includes a plate-shaped light guiding plate 3a, which is made of, for example, transparent acrylic resin, and a light source 3b composed of, for example, a cathode fluorescent tube or a LED (light emitting diode). The backlight 3 makes light, which is emitted from the light source 3b, surface-emitted through the light guiding plate 3a and irradiates the surface-emitted light onto the bottom side of the liquid crystal display panel 2.

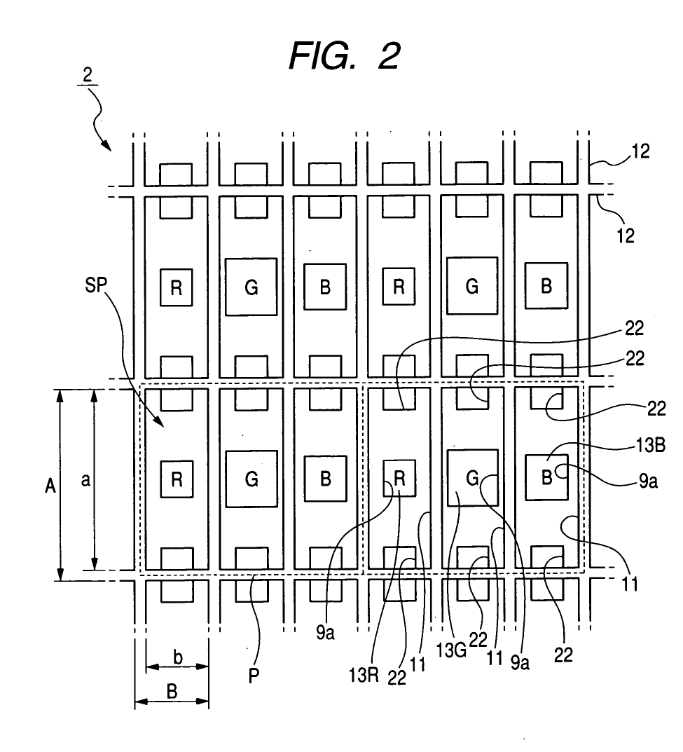

As shown in FIGS. 1 and 2, the liquid crystal display panel 2 is a color liquid crystal display panel in which one unit pixel P is formed by three dots (sub-pixels) sp corresponding to three primary colors of red, green, and blue. Specifically, the liquid crystal display panel 2, includes a first substrate (bottom-side substrate) 4 and a second substrate (front-side substrate) 5, which are disposed to be opposite to each other and are made of, for example, transparent glass, and a liquid crystal layer 6 interposed between the first substrate 4 and the second substrate 5. Edge portions of the pair of substrates 4 and 5 are sealed with a sealant 7 so as to be integrally connected to each other.

In addition, on a surface of the first substrate 4 facing the liquid crystal layer 6, a transflective layer 10, which includes a transparent organic film 8 having a plurality of fine concave portions 8a and a reflective film 9 formed on the transparent organic film 8 so as to reflect light incident from the second substrate 5 side and in which transmissive opening portions 9a are formed on a part of the reflective film 9 so as to transmit light incident from the first substrate 4 side, a light-shielding black matrix layer 12 for partitioning dot-corresponding regions 11 corresponding to respective dots sp, a color filter layer 13 in which color filters 13R, 13G, and 13B corresponding to red (R), green (G), and blue (B) are buried in the dot-corresponding regions 11 of the transflective layer 10 partitioned by the black matrix layer 12 and those color filters 13R, 13G, and 13B are periodically arranged, a transparent overcoat layer 14 for planarizing the black matrix layer 12 and the color filter layer 13, a first transparent electrode layer 15 for driving the liquid crystal layer 6, and an alignment film 16 for controlling the alignment of liquid crystal molecules in the liquid crystal layer 6 are sequentially stacked in this order. On the other hand, on a surface of the second substrate 5 facing the liquid crystal layer 6, a second transparent electrode layer 17 for driving the liquid crystal layer 6, a transparent overcoat layer 18 for planarizing the second electrode layer 17, and an alignment film 19 for controlling the alignment of liquid crystal molecules in the liquid crystal layer 6 are sequentially stacked in this order.

Further, at the bottom side of the liquid crystal display panel 2, that is, on a surface of the first substrate 4 not facing the liquid crystal layer 6, a retardation film 20a and a polarizer 21a are sequentially stacked. On the other hand, at the front side of the liquid crystal display panel 2, that is, on a surface of the second substrate 5 not facing the liquid crystal layer 6, a retardation film 20b and a polarizer 21b are sequentially stacked. In addition, the backlight 3 is disposed on the polarizer 21a located at the bottom side of the liquid crystal display panel 2.

Furthermore, the liquid crystal display panel 2 adopts a so-called passive matrix driving method and has a structure in which a plurality of first electrode layers 15 is arranged in a stripe shape with a predetermined gap interposed therebetween, a plurality of second electrode layers 17 is arranged in a stripe shape with a predetermined gap interposed therebetween, and the plurality of first electrode layers 15 and the plurality of second electrode layers 17 are arranged to be perpendicular to each other between the first substrate 4 and the second substrate 5. Thus, each of the dots sp is formed at each of the positions at which the first electrode layers 15 and the second electrode layers 17 cross. In addition, the pixel P is formed by three adjacent dots sp corresponding to the primary colors of red, green, and blue and the pixels p are arranged in a matrix, and thus an overall display area of the liquid crystal panel 2 is formed.

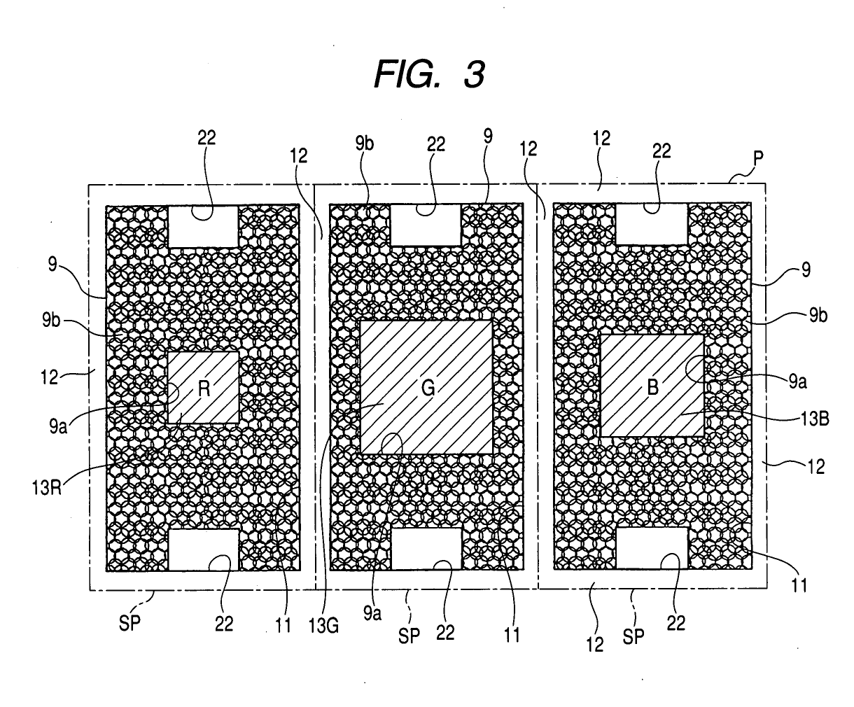

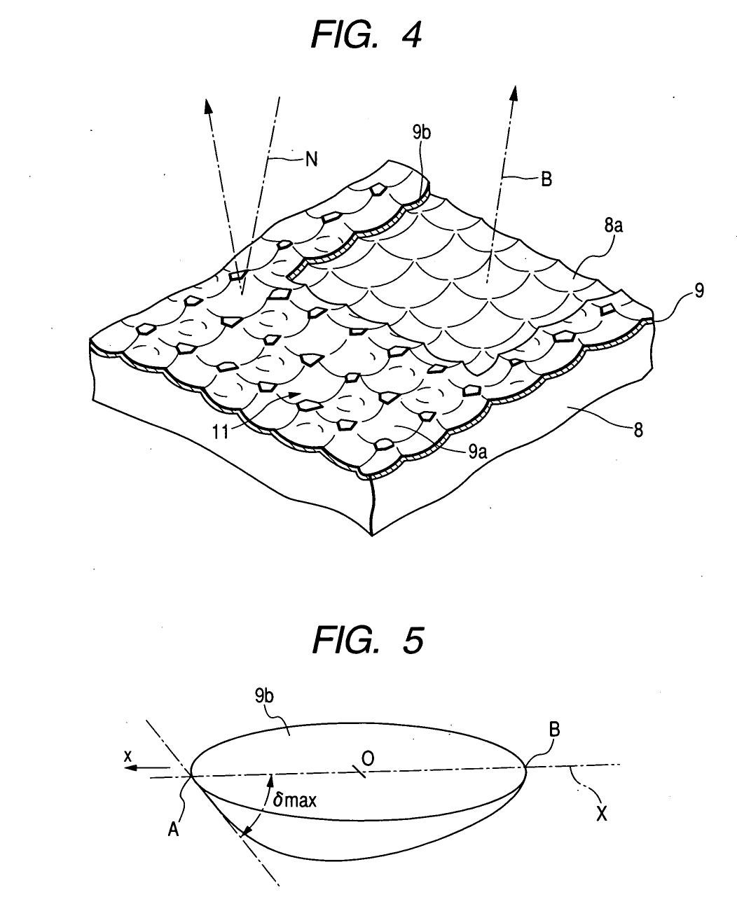

As shown in FIGS. 3 and 4, in the transflective layer 10 within each dot-corresponding region 11, the transmissive opening portion 9a formed on the reflective film 9 forms a transmissive region through which light incident from the first substrate 4 side is transmitted, and a remaining part of the reflective film 9 excluding the transmissive opening portion 9a forms a reflective region from which light incident from the second substrate 5 side is reflected. In addition, the reflective film 9 is made of a metal material having a high reflectance, such as aluminum, silver, or alloy thereof. On a surface of the reflective film 9, a plurality of fine concave portions 9b, of which the shapes of cross-sectional surfaces to be described later are individually controlled, is formed so as to efficiently diffuse and reflect light.

Specifically, since the shapes of the concave portions 8a are transferred onto the surface of the reflective film 9, the fine concave portions 9b, each of which a surface forms a part of a spherical surface, are irregularly formed to be adjacent to one another.

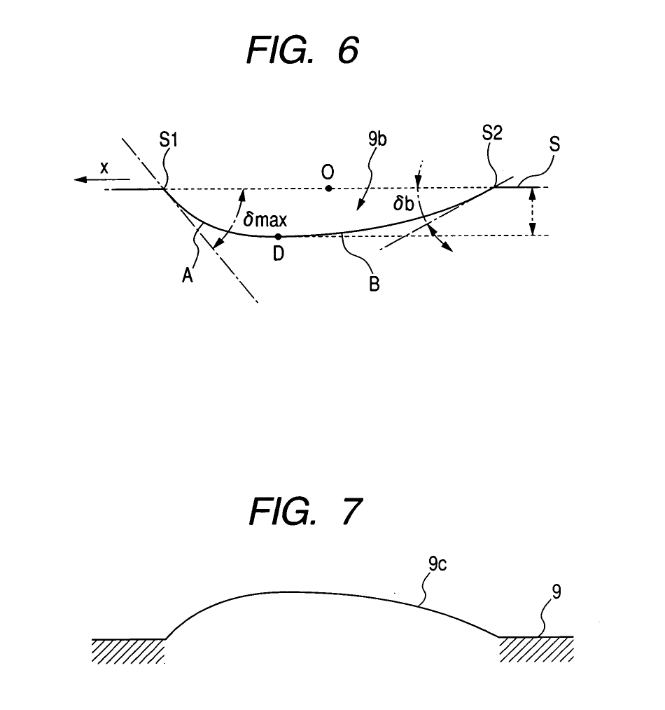

Here, as schematically shown in FIGS. 5 and 6, the shape of the surface of the concave portion 9b at a specific longitudinal section plane X is formed by a first curve A reaching from one peripheral portion S1 to a deepest point D and a second curve B which is continuous to the first curve A and reaches from the deepest point D to another peripheral portion S2. The inclination angle of each of the first and second curves A and B with respect to a surface S at the deepest point D is zero, and the first and second curves A and B are connected to each other at the deepest point D. The inclination angle of the first curve A with respect to the surface S is steeper than that of the second curve B with respect to the surface S, and the deepest point D is located to deviate from a center O of the concave portion 9b toward the x direction. That is, a mean value of absolute values of the angles of inclination of the first curve A with respect to the surface S is larger than that of a mean value of absolute values of the angles of inclination of the second curve B with respect to the surface S. Specifically, in the concave portions 9b, the mean value of the absolute values of the angles of inclination of the first curve A with respect to the surface S is irregularly distributed within a range of 1 to 89°, the mean value of the absolute values of the angles of inclination of the second curve B with respect to the surface S is irregularly distributed within a range of 0.5 to 88°.

Since the angles of inclination of the first and second curves A and B vary gently, the maximum angle (absolute value) δmax of inclination of the first curve A is larger than the maximum angle (absolute value) δb of inclination of the second curve B. In addition, the inclination angle of the deepest point D, at which the first curve A and the second curve B are connected to each other, with respect to the surface S is zero, and the first curve A having a minus-value inclination angle and the second curve B having a plus-value inclination angle are gently continuous. In addition, in the concave portions 9b, the maximum angles δmax and δb of inclination of the first and second curves A and B are irregularly distributed within a range of 2 to 90°. However, in most of the concave portions 9b, the maximum angle δmax of inclination is irregularly distributed within a range of 4 to 35°.

Furthermore, a concave surface of the concave portion 9b has a minimum point (point which is located on a curve and at which the inclination angle is zero) D, and assuming that the distance between the minimum point D and the surface S is a depth d of the concave portion 9b, the depth d is irregularly distributed in a range of 0.1 to 3 μm. In addition, the specific longitudinal section planes X of the concave portions 9b are formed in the same direction. That is, all of the concave portions 9b are formed such that the directions x shown in FIGS. 5 and 6 are equal.

In addition, the transflective layer 10 has a configuration in which the plurality of concave portions 9b is formed on the reflective film 9; however, the transflective layer 10 is not limited to the configuration. For example, as shown in FIG. 7, a plurality of fine convex portions 9c may be formed on the surface of the reflective film 9.

Further, as shown in FIGS. 1, 2, and 3, the transflective layer 10 is partitioned by the stripe-shaped black matrix layer 12 in a matrix, and each rectangular region partitioned by the black matrix layer 12 forms the dot-corresponding region 11. The black matrix layer 12 is a light-shielding wall for preventing light beams from being mixed between the color filters 13R, 13G, and 13B and is formed to extend in horizontal and vertical directions along sides of the dot-corresponding region 11. In addition, one of the color filters 13R, 13G, and 13B corresponding to red (R), green (G), and blue (B) is buried within each of the dot-corresponding regions 11 partitioned by the black matrix layer 12. In addition, on the color filter layer 13, the color filters 13R, 13G, and 13B are periodically arranged in a stripe shape.

Further, the black matrix layer 12 is configured to extend over the transflective layer 10 in horizontal and vertical directions; however, the black matrix layer 12 is not limited to the configuration. For example, the black matrix layer 12 may be configured to extend in only one of the horizontal and vertical directions corresponding to the sides of each dot-corresponding region 11.

Furthermore, a pixel-corresponding region corresponding to each pixel P has a square shape by means of three adjacent dot-corresponding regions 11R, 11G, and 11B provided with the color filters 13R, 13G, and 13B corresponding to red (R), green (G), and blue (B). In addition, the color filter layer 13 has a configuration in which the color filters 13R, 13G, and 13B are periodically arranged in a stripe shape; however, the color filter layer 13 is not limited to the configuration. For example, the color filter layer 13 may have a configuration in which the color filters 13R, 13G, and 13B are periodically arranged in various ways, such as a mosaic shape or a triangular shape.

The color filter layer 13 is formed with reflective opening portions 22 through which the part of the reflective film 9 is exposed. That is, in the dot-corresponding regions 11, the reflective opening portions 22 are formed on parts of the color filters 13R, 13G, and 13B, and thus the part of the reflective film 9 within the reflective region is exposed. Accordingly, it is possible to improve the reflection efficiency of the reflective film 9 within the reflective region.

In addition, the reflective opening portion 22 is provided at the location defined by the black matrix layer 12. Specifically, a pair of reflective opening portions 22 is provided at the locations defined by the black matrix layers 12 which are disposed to be opposite to each other with the dot-corresponding region 11 interposed therebetween. The pair of reflective opening portions 22 has a rectangular shape and is provided to be disposed at approximately the same locations with respect to the longitudinal direction of the dot-corresponding region 11. On the other hand, each of the transmissive opening portions 9a formed on the reflective film 9 is provided to be disposed further inward of the dot-corresponding region 11 than the reflective opening portions 22. Specifically, the transmissive opening portion 9a has a rectangular shape and is provided between the pair of reflective opening portions 22 within each dot-corresponding region 11, that is, at approximately a central portion of each dot-corresponding region 11.

Here, as shown in FIG. 2, the effective aperture ratio of each dot-corresponding region 11 can be expressed as a ratio (a×b)/(A×B) of an area (a×b) of the dot-corresponding region 11 not including the black matrix layer 12 to an area (A×B) of the dot-corresponding region 11, and the effective aperture ratio of each dot-corresponding region 11 is approximately 75%. In addition, as shown in FIG. 2, the transmittance of the transmissive opening portion 9a within the dot-corresponding region 11 can be expressed as a ratio of a total area of the transmissive opening portion 9a to the area (A×B) of the dot-corresponding region 11, and the transmittance of the reflective opening portion 22 within the dot-corresponding region 11 can be expressed as a ratio of a total area of the reflective opening portion 22 to the area (A×B) of the dot-corresponding region 11.

Preferably, the aperture ratio of the transmissive opening portion 9a in each dot-corresponding region 11 is within a range of 15 to 50%, and more preferably, the aperture ratio of the transmissive opening portion 9a in each dot-corresponding region 11 is within a range of 25 to 40%. In addition, in the transflective layer 10, it is possible to set the aperture ratios of the transmissive opening portions 9a in the dot-corresponding regions 11 to be different for each of the color filters 13R, 13G, and 13B corresponding to red (R), green (G), and blue (B).

Here, person's visibility with respect to a color tends to be high for green-colored light and low for red-colored light. Accordingly, it is preferable to set the aperture ratio of the transmissive opening portion 9a corresponding to each of the color filters 13R, 13G, and 13B such that the aperture ratio of the transmissive opening portion 9a in the dot-corresponding region 11 formed with the green (G) color filter 13G is highest and the aperture ratio of the transmissive opening portion 9a in the dot-corresponding region 11 formed with the red (R) color filter 13R is lowest. Specifically, it is preferable that the aperture ratio of the transmissive opening portion 9a in the dot-corresponding region 11 formed with the red (R) color filter 13R be within a range of 15 to 40%, and it is more preferable that the aperture ratio of the transmissive opening portion 9a in the dot-corresponding region 11 formed with the red (R) color filter 13R be within a range of 20 to 35%. In addition, it is preferable that the aperture ratio of the transmissive opening portion 9a in the dot-corresponding region 11 formed with the green (G) color filter 13G be within a range of 25 to 50%, and it is more preferable that the aperture ratio of the transmissive opening portion 9a in the dot-corresponding region 11 formed with the green (G) color filter 13G be within a range of 30 to 45%. Moreover, it is preferable that the aperture ratio of the transmissive opening portion 9a in the dot-corresponding region 11 formed with the blue (B) color filter 13B be within a range of 16 to 45%, and it is more preferable that the aperture ratio of the transmissive opening portion 9a in the dot-corresponding region 11 formed with the blue (B) color filter 13B be within a range of 25 to 40%. Thus, it is possible to perform the brightness correction corresponding to the person's visibility with respect to a color and to perform high-brightness color display with excellent color reproducibility in a transmissive mode.

In the same manner, in the color filter layer 13, it is possible to set the aperture ratios of the reflective opening portions 22 in the dot-corresponding regions 11 to be different for each of the color filters 13R, 13G, and 13B corresponding to red (R), green (G), and blue (B). Even here, due to the person's visibility with respect to a color, it is preferable to set the aperture ratio of the reflective opening portion 22 corresponding to each of the color filters 13R, 13G, and 13B such that the aperture ratio of the reflective opening portion 22 in the dot-corresponding region 11 formed with the green (G) color filter 13G is highest and the aperture ratio of the reflective opening portion 22 in the dot-corresponding region 11 formed with the red (R) color filter 13R is lowest. Specifically, it is preferable that the aperture ratio of the reflective opening portion 22 in the dot-corresponding region 11 formed with the red (R) color filter 13R be within a range of 2 to 10%, and it is more preferable that the aperture ratio of the reflective opening portion 22 in the dot-corresponding region 11 formed with the red (R) color filter 13R be within a range of 5%. In addition, it is preferable that the aperture ratio of the reflective opening portion 22 in the dot-corresponding region 11 formed with the green (G) color filter 13G be within a range of 0 to 20%, and it is more preferable that the aperture ratio of the reflective opening portion 22 in the dot-corresponding region 11 formed with the green (G) color filter 13G be within a range of 15 to 17%. Moreover, it is preferable that the aperture ratio of the reflective opening portion 22 in the dot-corresponding region 11 formed with the blue (B) color filter 13B be within a range of 5 to 20%, and it is more preferable that the aperture ratio of the reflective opening portion 22 in the dot-corresponding region 11 formed with the blue (B) color filter 13B be within a range of 7 to 12%. Thus, it is possible to perform the brightness correction corresponding to the person's visibility with respect to a color and to perform high-brightness color display with excellent color reproducibility in a reflective mode.

In the color liquid crystal display device 1 having the configuration described above, under a bright environment, such as the outdoors during the daytime, the backlight 3 is turned off and the liquid crystal display panel 2 is displayed in a reflective mode. Here, external light N incident from the second substrate 5 side of the liquid crystal display panel 2 is reflected from the reflective region of the transflective layer 10, that is, the reflective film 9 to illuminate the liquid crystal display panel 2. On the other hand, under a dark environment, such as night time or a dark room, the backlight 3 is turned on so as to perform the display of the liquid crystal display panel 2 in a transmissive mode. Here, illumination light B, which is emitted from the backlight 3 and is incident from the first substrate 4 side of the liquid crystal display panel 2, is transmitted through the transmissive region of the transflective layer 10, that is, the transmissive opening portion 9a to illuminate the liquid crystal display panel 2. Further, in the reflective and transmissive modes, a displayed color of each pixel P is controlled by controlling a driving voltage, which is applied between the first electrode layer 15 and the second electrode layer 17, for each of the three dots (sub-pixels) sp corresponding to red, green, and blue colors of each pixel P. Thus, it is possible to perform the color display of the liquid crystal display panel 2.

Furthermore, in the liquid crystal display panel 2, it is possible to improve the reflection efficiency of the reflective film 9 within the reflection region by forming the reflective opening portions 22, through which a part of the reflective film 9 is exposed, on the color filters 13R, 13G, and 13B. Accordingly, in the color liquid crystal display device 1 having the liquid crystal display panel 2, since the transmissive opening portion 9a is formed on the part of the reflective film 9 and the reflective opening portion 22 through which the part of the reflective film 9 is exposed is formed on the color filter layer 13, it is possible to perform high-brightness color display with excellent color reproducibility in a transmissive mode and to perform high-brightness color display with excellent color reproducibility in a reflective mode even when the film thicknesses of color filters are set to be equal and the coloring levels thereof are set to be equal.

Further, in the color liquid crystal display device 1, since a sectional shape of the reflective film 9 can be controlled according to the design, it is possible to obtain a desired reflection-viewing angle characteristic and to obtain an even more high-brightness color display with the excellent color reproducibility in a reflective mode.

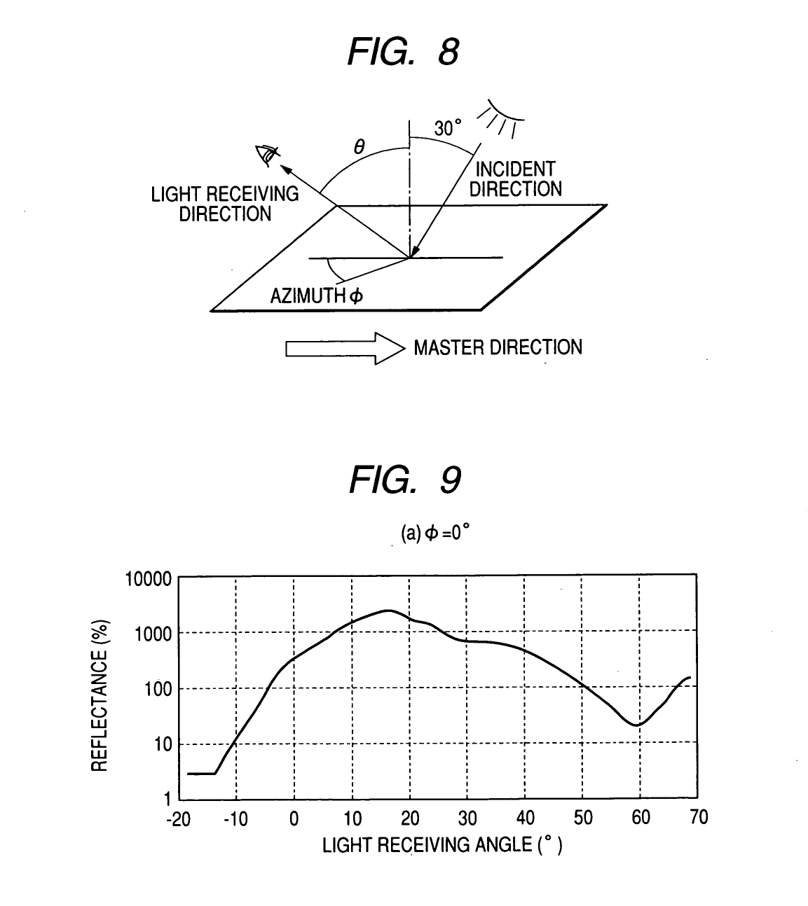

Here, as schematically shown in FIG. 8, the reflection-viewing angle characteristic of the liquid crystal display panel 2 has been measured. That is, assuming that the external light N is incident on a display screen of the liquid crystal display panel 2 at an incidence angle 30° and the direction of specular reflection with respect to the display screen is set to an azimuth angle ø=0°, when the azimuth angle ø=0°, 90°, and 270° is set to a central point, the relationship between a receiving angle θ, which is obtained when the viewing angle is widened over a range from −20° to 70° with respect to each perpendicular position (0°), and the reflectance has been measured.

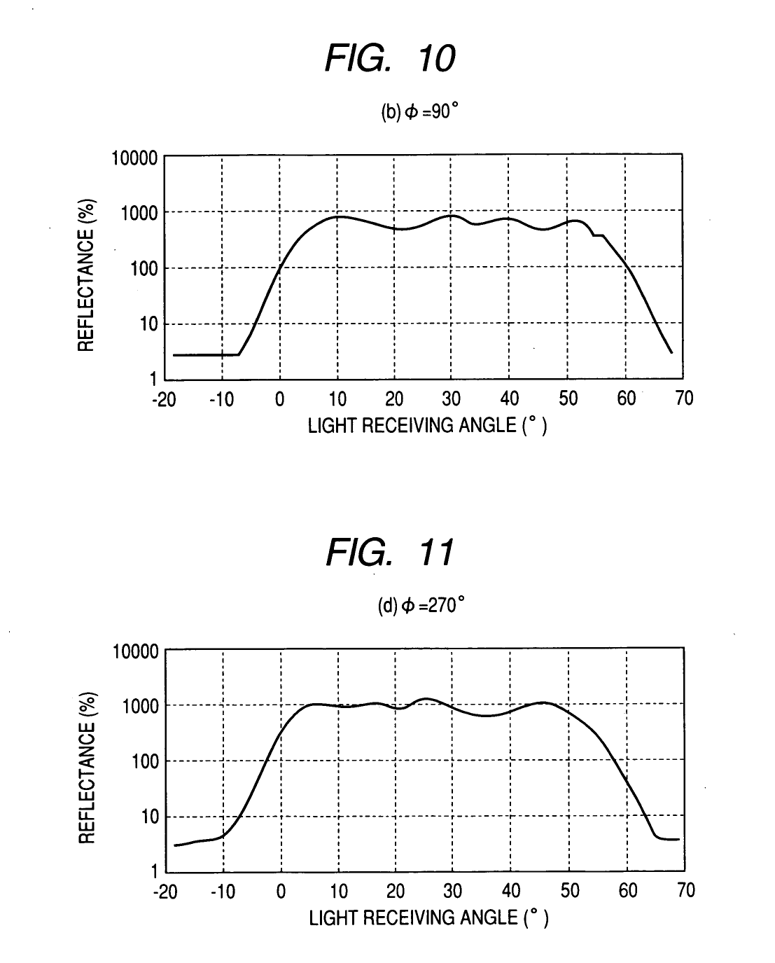

In the case of the azimuth angle ø=0° shown in FIG. 9, an integral value of a reflectance at a receiving angle smaller than an angle of 30°, which is an angle of specular reflection with respect to a display screen S, is larger than an integral value of a reflectance at a receiving angle larger than the angle of specular reflection. That is, reflected light can have even larger reflection intensity in the vicinity of a receiving angle of 15°. On the other hand, in the case of the azimuth angle ø=90° shown in FIG. 10, the reflectance is approximately constant within a range of ±20° with the position of a reflection angle of 30°, which is the specular direction, as a central point, and thus a uniform and bright display can be performed within this range. In the same manner, in the case of the azimuth angle ø=270° shown in FIG. 11, the reflectance is approximately constant within a range of ±20° with the position of a reflection angle of 30°, which is the specular direction, as a central point, and thus a uniform and bright display can be performed within this range. As described above, the liquid crystal display panel 2 has a reflection-viewing angle characteristic in which reflected light is focused in a specific direction.

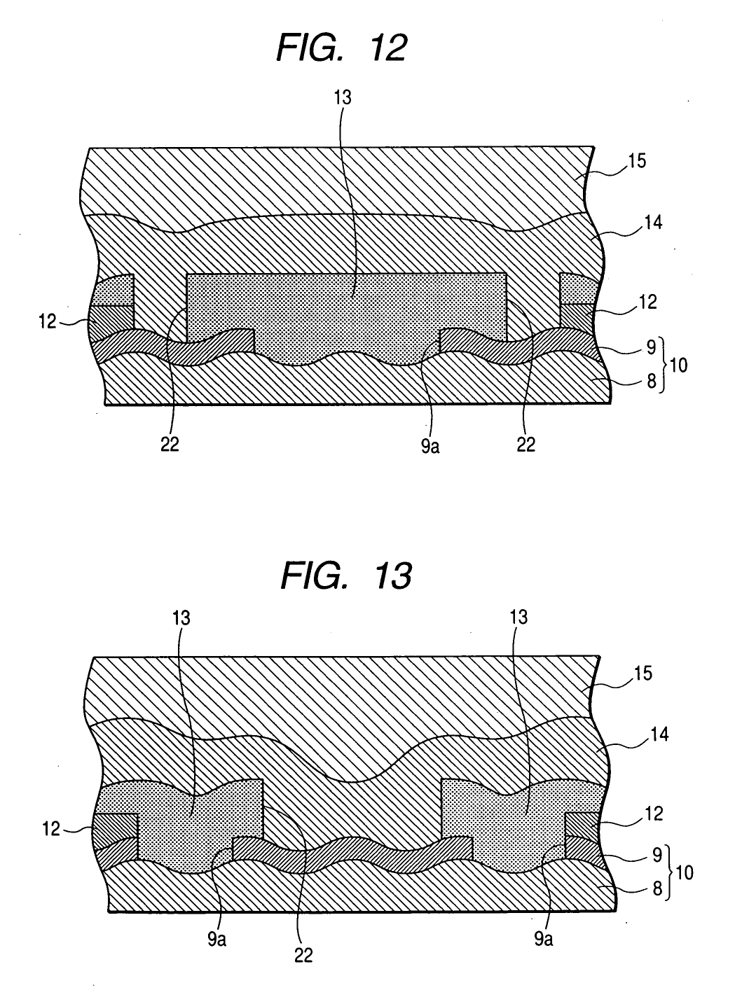

Further, as shown in FIG. 12, in the liquid crystal display panel 2, since the reflective opening portions 22 are provided at the locations, which are defined by the black matrix layer 12, within the dot-corresponding region 11, it is possible to even more planarize a surface of the overcoat layer 14 which covers the transflective layer 10 on which the black matrix layer 12 and the color filter layer 13 are formed.

More specifically, the liquid crystal display panel 2 is configured such that the pair of reflective opening portions 22 is formed in parallel in the longitudinal direction of the dot-corresponding region 11 and at the locations, which are defined by the black matrix layer 12, within the dot-corresponding region 11 and the transmissive opening portion 9a is formed to be disposed at approximately the central portion of each dot-corresponding region 11. In this case, in the liquid crystal display panel 2, it is possible to reduce the thickness difference between a portion of the liquid crystal layer 6 corresponding to the transmissive opening portion 9a and a portion of the liquid crystal layer 6 corresponding to the reflective opening portion 22 and to reduce the difference between driving voltages in transmissive and reflective modes.

On the other hand, as a comparative example with respect to the liquid crystal display panel 2, a liquid crystal display panel shown in FIG. 13 is configured such that the pair of transmissive opening portions 9a is formed in parallel in the longitudinal direction of the dot-corresponding region 11 and at the locations, which are defined by the black matrix layer 12, within the dot-corresponding region 11 and the reflective opening portion 22 is formed to be disposed at approximately the central portion of each dot-corresponding region 11. In this case, the thickness difference between a portion of the liquid crystal layer 6 corresponding to the transmissive opening portion 9a and a portion of the liquid crystal layer 6 corresponding to the reflective opening portion 22 becomes larger.

As such, in the liquid crystal display panel 2, it is possible to reduce the panel gap by reducing the thickness difference between a portion of the liquid crystal layer 6 corresponding to the transmissive opening portion 9a and a portion of the liquid crystal layer 6 corresponding to the reflective opening portion 22. As a result, since the difference between the driving voltages can be reduced, it is possible to improve the contrast, gray-scale level, color reproducibility, or the like at the reflective and transmissive modes.

Further, even though one transmissive opening portion 9a is formed within one dot-corresponding region 11 in the transflective layer 10, the invention is not limited thereto. For example, a plurality of transmissive opening portions 9a may be formed within one dot-corresponding region 11. In addition, the shape of the transmissive opening portion 9a is not limited to a rectangular shape but may be changed in various ways.

Furthermore, even though the pair of reflective opening portions 22 is formed within one dot-corresponding region 11 in the color filter layer 13, the invention is not limited thereto. For example, only one reflective opening portion 22 may be formed within one dot-corresponding region 11 or three or more reflective opening portions 22 may be formed within one dot-corresponding region 11. In addition, the shape of the reflective opening portion 22 is not limited to the rectangular shape described above but may be changed in various ways. In addition, the color filter layer 13 is not limited to have the configuration in which the pair of reflective opening portions 22 is formed in parallel in the longitudinal direction of the dot-corresponding region 11 and at the locations, which are defined by the black matrix layer 12, within the dot-corresponding region 11, but the pair of reflective opening portions 22 may be formed in parallel in the lateral or diagonal direction of the dot-corresponding region 11. In addition, even with this configuration, since it is possible to reduce the thickness difference between a portion of the liquid crystal layer 6 corresponding to the transmissive opening portion 9a and a portion of the liquid crystal layer 6 corresponding to the reflective opening portion 22, it is possible to reduce the difference between driving voltages at the transmissive and reflective modes.

Further, in the liquid crystal display panel 2, one unit pixel is formed by three dots corresponding to the three primary colors of red, green, and blue. However, as long as one unit pixel is formed by a plurality of dots corresponding to different colors, for example, the rates of respective color filters may be differently set or four or more color filters corresponding to different colors may be periodically arranged. Alternatively, in some cases, it is possible to periodically arrange color filters corresponding to cyan (C), magenta (M), and yellow (Y), which correspond to red, green, and blue colors described above.

In addition, the invention is not limited to be applied to the passive-matrix-driving-type liquid crystal display panel 2. For example, even in a case of an active-matrix-driving-type liquid crystal display panel using a thin film transistor or a thin film diode as a switching element, the invention can have a desired result.

1. A transflective liquid crystal display panel comprising:
first and second substrates disposed to be opposite to each other;
a liquid crystal layer sealed between the first and second substrates;
a transflective layer having a reflective film formed on a surface of the first substrate facing the liquid crystal layer so as to reflect light incident from the second substrate side, a transmissive opening portion being formed on a part of the reflective film so as to transmit light incident from the first substrate side therethrough;
a black matrix layer which is formed to extend at least in an in-plane direction of the transflective layer so as to partition dot-corresponding regions corresponding to respective dots; and
a color filter layer which has color filters corresponding to different colors disposed in the dot-corresponding regions of the transflective layer partitioned by the black matrix layer, the color filters being periodically arranged,
wherein the color filter layer has a reflective opening portion for exposing the part of the reflective film.

2. The transflective liquid crystal display panel according to claim 1,
wherein one unit pixel is formed by three dots corresponding to primary colors of red, green, and blue.

3. The transflective liquid crystal display panel according to claim 1,
wherein the reflective film has a plurality of fine concave or convex portions formed on a surface thereof.

4. The transflective liquid crystal display panel according to claim 1,
wherein the black matrix layer is formed in a direction along sides of the respective dots.

5. The transflective liquid crystal display panel according to claim 1,
wherein the reflective opening portion is formed at a location within each of the dot-corresponding regions, the location being defined by the black matrix layer.

6. The transflective liquid crystal display panel according to claim 5,
wherein a pair of reflective opening portions is formed at locations defined by the black matrix layers which are disposed to be opposite to each other with each of the dot-corresponding regions interposed therebetween.

7. The transflective liquid crystal display panel according to claim 6,
wherein the pair of reflective opening portions is formed at approximately the same locations with respect to a longitudinal direction of each of the dot-corresponding regions.

8. The transflective liquid crystal display panel according to claim 1,
wherein the transmissive opening portion is provided to be disposed further inward of the dot-corresponding region than the reflective opening portions.

9. The transflective liquid crystal display panel according to claim 6,
wherein the transmissive opening portion is provided to be disposed between the pair of reflective opening portions within each of the dot-corresponding regions.

10. The transflective liquid crystal display panel according to claim 1,
wherein a plurality of reflective opening portions is provided within each of the dot-corresponding regions.

11. The transflective liquid crystal display panel according to claim 1,
wherein a plurality of transmissive opening portions is provided within each of the dot-corresponding regions.

12. The transflective liquid crystal display panel according to claim 1,
wherein, in the color filter layer, an aperture ratio of the reflective opening portion in each of the dot-corresponding regions is set to be different for each of the color filters corresponding to the different colors.

13. The transflective liquid crystal display panel according to claim 12,
wherein the color filter layer has a structure in which color filters corresponding to red, green, and blue colors are periodically arranged, and
in the color filter layer, the aperture ratio of the reflective opening portion in the dot-corresponding region formed with the green color filter is highest and the aperture ratio of the reflective opening portion in the dot-corresponding region formed with the red color filter is lowest.

14. The transflective liquid crystal display panel according to claim 1,
wherein, in the transflective layer, an aperture ratio of the transmissive opening portion in each of the dot-corresponding regions is set to be different for each of the color filters corresponding to the different colors.

15. The transflective liquid crystal display panel according to claim 14,
wherein the color filter layer has a structure in which color filters corresponding to red, green, and blue colors are periodically arranged, and
in the transflective layer, the aperture ratio of the transmissive opening portion in the dot-corresponding region formed with the green color filter is highest and the aperture ratio of the transmissive opening portion in the dot-corresponding region formed with the red color filter is lowest.

16. The transflective liquid crystal display panel according to claim 1,
wherein, in the transflective layer, fine concave portions, each of which a surface forms a part of a spherical surface, are irregularly formed on a surface of an organic film formed below the reflective film so as to be adjacent to one another, and thus a plurality of fine concave portions is formed on a surface of the reflective film formed on the organic film.

17. A color liquid crystal display device comprising:
the transflective liquid crystal display panel according to claim 1; and
a backlight that illuminates light from the first substrate side of the transflective liquid crystal display panel.

18. The transflective liquid crystal display panel according to claim 2,
wherein the reflective film has a plurality of fine concave or convex portions formed on a surface thereof.
